(19) United States
(12) Patent Application Publication
(10) Pub. No.: US 2026/0070062 A1
(43) Pub. Date: Mar. 12, 2026

(54) METHODS AND SYSTEMS OF MATERIAL RECOVERY

(71) Applicant: REMEDY BIOLOGICS LIMITED, Meath (IE)

(72) Inventor: Paul Leonard, Meath (IE)

(21) Appl. No.: 19/107,817

(22) PCT Filed: Aug. 31, 2023
(86) PCT No.: PCT/EP2023/073970

§ 371 Date: Feb. 28, 2025

(30) Foreign Application Priority Data
Sep. 1, 2022 (GB) 2212732.8

(51) Int. Cl. B01L 3/00

(52) U.S. Cl. CPC B01L 3/50857; B01L 2200/025; B01L 2200/026; B01L 2200/0689; B01L 2200/148; B01L 2300/0829; B01L 2300/0838

(57) ABSTRACT

A method of recovering the contents from a microcapillary array having a plurality of wells each with mutually opposed first and second openings. The method comprises: a) identifying a target well of the array for recovery from among a plurality of wells of the array; b) bringing first and second recovery ducts into contact with the array in alignment respectively with the first and second openings of the identified target well to effect fluid communication between those ducts and that well through the respective first and second openings; and c) by flowing fluid from the first recovery duct through the identified target well and into the second recovery duct, conveying contents of that well into the second recovery duct.

### TECHNICAL FIELD

This invention is related to the identification and recovery of biological cells and cell components.

### BACKGROUND

Microtools that have been developed to allow in depth interrogation of individual cells in high throughput are improving understanding of biological processes at the single cell level and are opening up new possibilities for biological research. In relation to antibody discovery, these tools are now helping to maximise the full potential of well-established methodologies for antibody generation. Being complementary to both recombinant and native antibody secreting cells, some of these tools are finding widespread use in the field of monoclonal antibody (mAb) discovery which has developed into a thriving industry providing a diverse source of therapeutic and diagnostic and research reagents (Valerie Fitzgerald & Leonard, 2017). The intrinsic specificities of monoclonal antibodies for their target antigen are fundamental for their applications as research reagents, in the field of diagnostics and for therapy. Indeed, monoclonal antibodies are now the largest class of biological drugs.

One of the earliest and most fundamental obstacles in mAb drug development is how to identify the one or more mAbs with unique therapeutic properties from diverse libraries of billions of potential candidates. Depending on the starting source of antibodies, current solutions involve selection by displaying the antibody on the surface of a phage particle (Bradbury, Sidhu, Dübel, & McCafferty, 2011) or cell (Bowers et al., 2014) and selection by affinity-based biopanning (Ehrlich, Berthold, & Bailon, 2000) or FACS (de Kruif, Terstappen, Boel, & Logtenberg, 1995).

Searching for antigen-specific antibody secreting cells (ASCs) from large populations of hybridomas or native B cells normally involves spatially addressing cell populations into microtitre plates for analysis, followed by cloning by limiting dilution of positive wells to obtain monoclonality (Staszewski, 1984). Recent innovations in automation and miniaturisation of the antibody discovery process have resulted in the emergence of improved techniques for the discovery of ASCs such as microengraving of miniature wells (Love, Ronan, Grotenbreg, van der Veen, & Ploegh, 2006; Ogunniyi, Story, Papa, Guillen, & Love, 2009; Sendra, Lie, Romain, Agarwal, & Varadarajan, 2013), etched fibres (Biran & Walt, 2002), homogeneous cell spot assays (Jin et al., 2009) and microfluidic cell sorting (Debs, Utharala, Balyasnikova, Griffiths, & Merten, 2012; Diercks et al., 2009; Ryan, Ren, & Wu, 2011; Singhal, Haynes, & Hansen, 2010; Wheeler et al., 2003). These microtools facilitate phenotyping of single cells based on the products they secrete or consume which is a key bottleneck in many biotechnology applications (Wang et al., 2014).

The development of microcapillary-based microtools involves utilising porous, glass filters as an ultra-high throughput screening tool for antibody discovery. Glass filters can be manufactured by fusing bundles of capillaries, of a certain diameter (for example, 5-100 μm), and cutting them into slices (for example, approximately 1 mm thick or less). Dense packing of the capillaries provides stability and also drastically reduces redundant surface area. This results in significantly higher densities of potential assay chambers per unit area, compared to microengraved wells or microfluidic chambers. By spatially addressing antibody-secreting cells in the capillaries, it provides a powerful new tool to interrogate cells on a single cell basis. The capillaries can be filled with culture medium containing antibody-secreting cells. The cells grow and express antibodies into the medium, and specific signals from cells can be subsequently detected either in the capillary (i.e. a homogeneous assay) or on antigen coated removable surfaces which can be sealed to the open surface of the array (Valerie Fitzgerald & Leonard, 2017).

While microcapillary arrays or microarrays have demonstrated the discovery of antigen-specific ASCs with minimal difficulty, the ability to recover viable ASC's, especially mammalian cells, is limited with current approaches. Chen et al. recently describe an embodiment of the microcapillary microtool termed μSCALE (microcapillary single-cell analysis and laser extraction). Libraries (bacterial or yeast based) of protein variants are mixed with microbeads and loaded into the capillary array, a fluorescent, biochemical assay is performed and using fluorescence microscopy the intensity of each capillary is ascertained. Clones of interest are retrieved with a laser-based extraction method which works by disrupting the surface tension of the microcapillary and ejecting a portion of its contents onto a capture surface below the array. The authors demonstrate its utility in selecting antibodies from a naïve yeast display library (Chen et al., 2015). This method of cell retrieval limits the system to work with yeast or bacterial libraries as the optical cavitation method can result in membrane disruption in mammalian cells (Chen et al., 2015). This method is also limited in that the expunged contents are captured on a glass slide which needs to be changed after each extraction if single clonality is required.

A more efficient method of recovery is described by Fitzgerald et al., whereby the single capillary of interest is automatically located and the contents of the capillary recovered by ablating a hole in the sealant to allow a flow of nitrogen to simply blow the contents into a well of a 384 well plate positioned below the capillary array. Using this approach, the authors detail the analysis of recombinant libraries previously screened by phage display, screening of hybridomas and native B cells on a single cell basis and demonstrate the ability to perform highly multiplexed analysis in addition to functional screening (apoptosis and necrosis detection) (V. Fitzgerald et al., 2015). However, the Fitzgerald et al approach is an ‘open’ plate method whereby air pressure is used to blow the contents from a microcapillary into a media plate. This ‘open’method requires removal of the media plate to retrieve the cells of interest.

Other platforms, such as those described in WO2012007537A1 and later in US20140011690A1, can be used to discover, characterise and select specific interaction pairs from a heterogeneous population of millions or even billions of cells (i.e., for example, bacterial clones). For example, a very high-density microcapillary array may be reversibly attached to a solid substrate, wherein after screening, the array is removed from the substrate for cell collection from selected micropores.

Collection of viable cells is critical if target cells need to be propagated in culture post recovery. Laser-based extraction involving disruption of the surface tension of the microcapillary and ejection of a portion of its contents onto a capture surface below the array (US20140011690A1) can result in significant sample loss and loss of biological cell viability, limiting their applicability for applications such as human B cell discovery. Other approaches such as laser ablation and removal by pressurised air (WO2012007537A1) involves removing cells from a microcapillary array into an open well plate but is limited for autologous cell therapy manufacturing as a closed system is required to ensure sample sterility and integrity.

O'Reilly, B “Design and Fabrication of Biomedical Platform Technologies for Improved Diagnostic Performance” Dublin City University, May 2016, considers existing methods for microcapillary recovery and hypothesises potential alternatives.

There is therefore a need for improved methods of cell recovery allowing for high precision isolation of specific cells with improved survival rates. Such methods will allow in line further cell characterisation and expansion, along with ensuring sample integrity for clinical utility and GMP manufacturing.

### SUMMARY OF THE INVENTION

The present invention contemplates methods that improve upon existing recovery processes by a technique comprising one or more recovery nozzles microcapillaries or microtubing, aligned above and/or below a target microcapillary within an array of microcapillaries and by flowing a liquid through the aligned microcapillaries, so that the sample, for example growth media comprising a biological cell of interest, is removed from the array of microcapillaries without loss of sample or loss of biological cell of interest.

In a first aspect, there is provided a method of recovering the contents of a microcapillary array. The method comprises providing a microcapillary array, wherein the microcapillary array comprises a plurality of wells, each well comprising a first and a second opening. The method further comprises identifying at least one target well for recovery, aligning and contacting a first and a second recovery nozzle respectively to the first and second openings of the at least one target well, and flowing fluid from the first recovery nozzle through the at least one target well and into the second recovery nozzle, such that the contents of the at least one target well are taken up into the second recovery nozzle.

In some embodiments, the method further comprises applying at least one sealing film to the microcapillary array prior to the step of contacting the first and second recovery nozzles to the openings, such that the sealing film seals the first and/or the second openings of the plurality of wells. Two sealing films may be applied to the microcapillary array prior to the step of aligning the first and second recovery nozzles to the openings, such that the sealing films seal the first and the second openings of the plurality of wells. Before contacting the recovery nozzles to the openings of the target well, there may be included a step of creating an aperture in the sealing film or films at a location corresponding to the first and/or second opening of the at least one target well, such that the target well and the first and second recovery nozzles can be put into fluid communication once aligned. In some embodiments, the aperture or apertures are created by a laser or lasers.

In some embodiments, a further target well is identified for recovery, and the steps of aligning and contacting the recovery nozzles, and of flowing fluid from the first recovery nozzle through the at least one target well and into the second recovery nozzle are repeated to recover the contents of the further target well.

The first and/or second recovery nozzle may be coupled to a pressure source, which may comprise a pump.

In some embodiments, the method further comprises a step of calibrating the positions of at least one of the first and second recovery nozzles, the laser or lasers, the microcapillary array. A calibration camera may be used to determine the positions of the first and second recovery nozzles, the laser or lasers, and/or the microcapillary array. The determined positions may be compared to identify one or more of a laser-camera offset, a nozzle-camera offset, and/or a laser-nozzle offset.

The contents of the target well may comprise liquid media, and/or may comprise one or more biological cells. In some embodiments, before aligning the recovery nozzles to the openings of the target well, a step of contacting the microcapillary array with a population of heterogeneous cells is carried out, such that a sub-population comprising at least one of said cells enters at least one well of the microcapillary array. The method may comprise a step of incubating the microcapillary array under conditions to promote the secretion of molecules from said cells. The method may comprise a step of detecting a target sub-population of the heterogeneous cells and thereby identifying one or more target wells containing said sub-population. The target sub-population may be identified by determining interaction between at least one binding partner and a molecule produced by the target sub-population.

The method may further comprise reversibly attaching the microcapillary array to a substrate after the microcapillary array is contacted with a population of heterogeneous cells, such that part of the surface of the substrate is exposed to the contents of the wells of the microcapillary array, and wherein the substrate is removed before the step of aligning and contacting the first and second recovery nozzles to the target well. At least one binding partner may be attached to the substrate. In some embodiments, the microcapillary array is reversibly attached to two substrates, such that part of the surface of each substrate is exposed to the contents of the wells of the microcapillary array. Different binding partners may be attached to the two substrates.

Where used, the substrate or substrates are in some embodiments examined for interaction between at least one binding partner attached to the substrate and a molecule produced by the target sub-population in order to identify a target sub-population. The position of the interaction on the substrate may be used to identify the position of the target well containing the target subpopulation within the microcapillary array.

In some embodiments, at least one binding partner is present in the wells of the microcapillary array together with a population of heterogeneous cells.

In some embodiments, the method comprises depositing the recovered contents of the target well into a collection vessel. The recovered contents of different target wells may be deposited into different collection vessels or different sections of a collection vessel.

In a second aspect, there is provided a method of recovering the contents from a microcapillary array having a plurality of wells each with mutually opposed first and second openings, the method comprising identifying a target well of the array for recovery from among a plurality of wells of the array, bringing first and second recovery ducts into contact with the array in alignment respectively with the first and second openings of the identified target well to effect fluid communication between those ducts and that well through the respective first and second openings; and by flowing fluid from the first recovery duct through the identified target well and into the second recovery duct, conveying contents of that well into the second recovery duct. This aspect is intended to be modified with any of the optional features of the above aspect, where appropriate.

In a third aspect, there is provided a system for recovery of the contents of a microcapillary array. The system comprises an array stage for holding a microcapillary array, and a first and second recovery nozzle. At least one of the array stage, the first recovery nozzle and the second recovery nozzle are configured to be movable relative to the other components, such that the first and second recovery nozzles can be aligned with and contacted to a well in a microcapillary array held in the array stage.

The first and/or second recovery nozzle may be fluidly coupled to a source of a liquid, such that a liquid can be flowed between the first and second recovery nozzles, and through a well in a microcapillary array positioned between the first and second recovery nozzles. The first and/or second nozzle may be coupled to a pressure source, suitably comprising a pump.

The system may further comprise a penetrator for creating an aperture in a sealing film at a location corresponding to an opening of a target well. The penetrator may be configured to be movable relative to the microcapillary array. The penetrator may comprise a first laser, and may further comprise a second laser, wherein the first and second lasers are configured to create apertures in a sealing film on opposing sides of a microcapillary array held in the array stage.

The system may comprise one or more cameras to determine the position and/or target location of the penetrator. The system may comprise a first and second camera to determine the position and/or target location of the first and second lasers respectively. The system may comprise a calibration camera for determining the relative positions of the first and second recovery nozzles, the laser or lasers, and/or the microcapillary array.

The first and/or second nozzle may comprise a force feedback device to determine the pressure between the nozzle and a contacted surface. In some embodiments, the first and/or second nozzle comprises a deformable tip or coating.

In some embodiments, the system comprises a collection stage for holding a collection vessel, wherein the first and or second nozzles are configured to be able to deposit liquid into the collection vessel.

In some embodiments, at least one of the array stage, the first recovery nozzle, the second recovery nozzle, the collection stage, and the penetrator (where these components are included) are coupled to one or more positioning stages to move them relative to the other components. Suitably, the positioning stages can be moved with sub-micrometre precision. Typically, the positioning stages allow for movement in the XY and/or the Z direction, relative to the surface of a microcapillary array held in the array stage.

In a fourth aspect, there is provided a system for recovery of the contents of a microcapillary array, the system comprising components being an array stage for holding a microcapillary array, a first recovery duct and a second recovery duct. At least one of said components is movable relative to at least one other of said components to contact the first and second recovery ducts with a microcapillary array held in the array stage, those ducts being in mutual alignment with a well in that microcapillary array. This aspect is intended to be modified with any of the optional features of the above aspect, where appropriate.

In a fifth aspect, there is provided a method of identifying a sub-population of cells from a population of heterogeneous biological cells. The method comprises providing a microcapillary array, wherein the microcapillary array comprises a plurality of wells, each well comprising a first and a second opening; contacting said microcapillary array with a population of heterogeneous cells such that a sub-population comprising at least one of said cells enters at least one well of said microcapillary array; reversibly attaching the microcapillary array to a substrate such that part of the surface of the substrate is exposed to the contents of the wells of the microcapillary array, wherein at least one binding partner is attached to said substrate; incubating said microcapillary array under conditions to promote the secretion of molecules from said cells; removing said microcapillary array from said substrate; determining interaction between the at least one binding partner on said substrate and a secreted molecule, thereby identifying a target subpopulation of biological cells in a corresponding target microcapillary array well; aligning and contacting a first and a second recovery nozzle respectively to the first and second openings of the at least one target well; and flowing liquid from the first recovery nozzle through the at least one target well and into the second recovery nozzle, such that the target subpopulation of biological cells in the at least one target well are taken up into the second recovery nozzle.

This aspect is intended to be modifiable with any of the optional features of any of the aspects above, where appropriate. In particular, in some embodiments, the microcapillary array is reversibly attached to two substrates, suitably wherein different binding partners are attached to each substrate. In some embodiments, the position of the interaction on the substrate is used to identify the position of the target well containing the target subpopulation within the microcapillary array.

In a sixth aspect, there is provided a method of identifying a sub-population of cells from a population of heterogeneous biological cells the method comprising providing a microcapillary array, wherein the microcapillary array comprises a plurality of wells, each well comprising a first and a second opening; contacting said microcapillary array with a fluid comprising a population of heterogeneous cells and at least one binding partner, such that a sub-population comprising at least one of said cells enters at least one well of said microcapillary array; incubating said array of microcapillaries under conditions to promote the secretion of molecules from said cells, determining interaction between said at least one binding partner and a secreted molecule, thereby identifying a target subpopulation of biological cells in a corresponding target microcapillary array well; aligning and contacting a first and a second recovery nozzle respectively to the first and second openings of the at least one target well; and flowing liquid from the first recovery nozzle through the at least one target well and into the second recovery nozzle, such that the target subpopulation of biological cells in the at least one target well are taken up into the second recovery nozzle.

Again, this aspect is intended to be modifiable with any of the optional features of any of the above aspects, where appropriate.

In a seventh aspect, there is provided an electronic controller configured to carry out the steps of any one of the described method aspects.

### BRIEF DESCRIPTION OF THE DRAWINGS

FIG. 1 shows an illustration of example different biological recognition assays that can be performed within wells of a microcapillary array.

FIG. 2 shows a scanned image of a PDMS substrate resulting from an assay performed using a microcapillary array, with locations corresponding to a positive result identified with a brighter signal.

FIG. 3 shows a representation of a spatial normalisation process in order to map a substrate image (pattern) to a reference image that is a spatial representation of the microcapillary array in which an assay was carried out.

FIG. 4 shows (left to right) a reference image representing a microcapillary array; a pattern image of a substrate representing the results of said array; and the pattern image superimposed on the reference image.

FIG. 5A and B show an example illustration of two recovery nozzles (A) and a longitudinal cross-section thereof (B).

FIG. 6 shows a cross-section view of a liquid-liquid recovery process according to some embodiments of the invention. In 6A, the first and second recovery nozzles can move in the XY direction relative to the microcapillary array in order to align with a target well. In 6B, the XY movement is locked and the recovery nozzles are contacted with the array by relative movement in the Z direction. In 6C, movement in XY and Z directions is locked and liquid flow is initiated to recover the well contents.

FIG. 7A, B and C show further views of recovery nozzle(s) aligned and contacted to target wells in a microcapillary array.

FIG. 8A, B, C and D show views of two recovery nozzles aligned and contacted to each other or to target wells in a microcapillary array.

FIGS. 9A and 9B show views at different magnification from each side of a microcapillary array covered with a sealing film, with an aperture made in the sealing film by a laser over a target well.

FIGS. 10 to 12 show different views (respectively perspective, side-on and top-down views) of a simplified example recovery system comprising linear positioning stages, penetrators, recovery nozzles and tubes, illumination and camera systems, optical platforms and fluid flow devices. FIG. 12A shows a top-down view of an exemplary system with the components shown closer to scale, with FIG. 12B showing this in simplified form.

FIG. 13A, B, C and D illustrate a process of creating an aperture in a sealing film over a target well in a microcapillary array, followed by a liquid-liquid recovery process.

FIGS. 14A and 14B illustrate the positioning of integrated laser and camera systems each side of a microcapillary array, such that laser energy can be supplied to a sealing film on either side, and directed towards a specific location.

FIG. 15 shows a flowchart with an example of the steps involved in a calibration sequence according to some embodiments of the invention.

FIG. 16 shows a flowchart with an example of the steps involved in aligning recovery nozzles to each other during a calibration step.

FIG. 17 shows a flowchart with an example of the steps involved in calibration of the location of one or more recovery nozzles.

FIG. 18A and B are diagrams that indicate the determination of offsets between various components using a calibration camera, in side (A) and face (B) views.

FIG. 19 shows a flowchart with an example of the steps involved in calibrating the position of a laser and a location of laser ablation according to some embodiments of the invention.

FIG. 20 shows a flowchart with an example of the steps involved in calibrating the location of a target location on a microcapillary array from an image pixel location.

FIG. 21 shows a flowchart with an example of the steps involved in a liquid-liquid recovery process.

FIG. 22 shows a schematic of a method using a system according to an embodiment of the present invention, specifically, an assay to identify and isolate SA13 cells.

FIGS. 23A and 23B show images of SA13 cells recovered using the method of FIG. 22.

### DETAILED DESCRIPTION

### Definitions

Unless otherwise indicated, the practice of the present invention employs conventional techniques of chemistry, molecular biology, microbiology, recombinant DNA technology, and chemical methods, which are within the capabilities of a person of ordinary skill in the art. Such techniques are also explained in the literature, for example, M.R. Green, J. Sambrook, 2012, Molecular Cloning: A Laboratory Manual, Fourth Edition, Books 1-3, Cold Spring Harbor Laboratory Press, Cold Spring Harbor, NY; Ausubel, F.M. et al. (Current Protocols in Molecular Biology, John Wiley & Sons, Online ISSN: 1934-3647); B. Roe, J. Crabtree, and A. Kahn, 1996, DNA Isolation and Sequencing: Essential Techniques, John Wiley & Sons; J.M. Polak and James O'D. McGee, 1990, In Situ Hybridisation: Principles and Practice, Oxford University Press; M.J. Gait (Editor), 1984, Oligonucleotide Synthesis: A Practical Approach, IRL Press; and D.M. J. Lilley and J.E. Dahlberg, 1992, Methods of Enzymology: DNA Structure Part A: Synthesis and Physical Analysis of DNA Methods in Enzymology, Academic Press; Synthetic Biology, Part A, Methods in Enzymology, Edited by Chris Voigt, Volume 497, Pages 2-662 (2011); Synthetic Biology, Part B, Computer Aided Design and DNA Assembly, Methods in Enzymology, Edited by Christopher Voigt, Volume 498, Pages 2-500 (2011); RNA Interference, Methods in Enzymology, David R. Engelke, and John J. Rossi, Volume 392, Pages 1-454 (2005). Each of these general texts is herein incorporated by reference.

Prior to setting forth the invention, a number of definitions are provided that will assist in the understanding of the invention. Unless otherwise specified, the technical and scientific terms used herein have the same meaning as commonly understood by one of ordinary skill in the art. Expansion and clarification of some terms are provided herein. All publications, patent applications, patents and other references mentioned herein, if not otherwise indicated, are explicitly incorporated by reference.

The terms ‘microcapillary’, ‘micropore’, ‘microchamber’, ‘microtubing’ and ‘fibre’ as used herein, include both filaments and hollow capillary structures. These structures can range in size, typically being 5-500 micrometres in diameter and can be made of materials such as glass, metal, ceramic, plastics or any durable material that can be manufactured to the desired dimensions. Pluralities, typically a large number of microcapillaries bound adjacent to each other to form bundles of fused capillaries are herein or in the prior art termed ‘microcapillary array’, ‘micropore array’, ‘array’ and ‘array of longitudinally fused fibres’. A microcapillary within a microcapillary array can be referred to as a ‘cell’, ‘well’, ‘chamber’ or ‘pore’ as appropriate. In the present context, such structures are generally open at both ends, or in other words have two openings, typically two mutually-opposed openings.

The term ‘microcapillary array’ can differ in general size and in number of microcapillaries contained in the array. Typically, the diameter of the inner open area of a microcapillary ranges from 5-50 micrometres and the outer area diameter ranges from 7-50+ micrometres. The length of each microcapillary from one open end to the other typically ranges from 1-5 mm, but can be shorter or longer as desired.

The term ‘align’ and derivatives thereof, for example, ‘aligned nozzles’ or ‘aligned to an opening’ relates to two or more hollow structures or components positioned such that when these structures come in contact there is a continuous open hollow area that can permit the flow or passage of material and fluid from one structure to another, or in other words that they can be put in fluid communication with each other. The skilled person will be aware that the ability to align structures may in context imply certain limitations on the respective diameters and sizes of said structures, such that fluid communication can be achieved without excessive loss of material and/or fluid, as discussed further below.

The term ‘biological cell’, refers to any cell from an organism, including, but not limited to, insect, microbial, fungal (for example, yeast) or animal, (for example, mammalian) cells, and can include encapsulated and non-encapsulated viral particles and protoplasts, as well as similar structures.

The term ‘heterogeneous population of biological cells’ can mean a population of different cell types or a single cell type with exhibiting different characteristics. For example, this could include B cells that secrete different antibody molecules, with each B cell secreting one type of antibody. Other examples include tumour infiltrating lymphocytes that secrete cytokines, chemokines or cell killing molecules; immune cells that are activated due to co-culture with target disease cells and as a result secrete cytokines; or co-cultured cells that secrete communication signals that can be measured. The term ‘secretion of molecules’ as used herein, refers to the production of biological elements, such as but not limited to antibody molecules, by a biological cell so that the biological element is not bound to the biological cell but enters the liquid environment and can independently interact or bind with a specific

The term ‘biological element’ as used herein, refers to any bioreactive molecule. Non-limiting examples of these molecules include proteins, nucleic acids, peptides, antibodies, antibody fragments, enzymes, hormones, biological cells, and small molecules.

The term ‘bind’, ‘contact’, ‘interact’ or ‘attach’ as used herein, includes any physical attachment or close association, which may be permanent or temporary.

The term ‘binding partner’ or ‘binding agent’ as used herein, relates to the specific interaction between two or more biological elements, either or both of which may be the binding partner or agent. Such reactions are the result of interaction of, for example, an antibody and, for example, a protein or peptide, such that the interaction is dependent upon the presence of a particular structure (e.g., an antigenic determinant or epitope) on a protein. In other words, an antibody is recognizing and binding to a specific protein structure rather than to proteins in general. For example, if an antibody is specific for epitope “A”, the presence of a protein containing epitope A (or free, unlabelled A) in a reaction containing labelled “A” and the antibody will reduce the amount of labelled A bound to the antibody. Interactions with binding partners can in some cases be detected by the activity of fluorescent reporters which create a particular signal dependent on the presence or absence of an interaction. A binding partner may be immobilised on a solid substrate or within the wells of a microcapillary array, and may bind to an analyte being detected in a given assay. Alternatively, a binding partner may not be immobilised on either the solid substrate or on the micro-pores of the array. Example binding agents include proteins, polypeptides, peptides, nucleic acids (nucleotides, oligonucleotides and polynucleotides), antibodies, ligands, saccharides, polysaccharides, receptors, antibiotics, test compounds (particularly those produced by combinatorial chemistry). Multiple different binding partners may be used in a single assay.

The term ‘in solution’ as used herein, refers to the biological elements, biological cells or binding interactions that occur in free form as opposed to being immobilised onto a solid surface. ‘In solution’ binding assays can also be termed ‘homogeneous assays’.

The term ‘substrate’ and derivatives thereof as used herein, refers to a material to which a binding agent can be attached or otherwise immobilised, and which can be reversibly attached to a microcapillary array. Typically, the substrate is attached to a microcapillary array during an assay, and removed for detection of assay outcome afterwards. Various possibilities are available for the materials used, as discussed herein, and may depend on the binding agents, and the conditions inside the microcapillary array.

### Microcapillary Array Assays and Target Identification

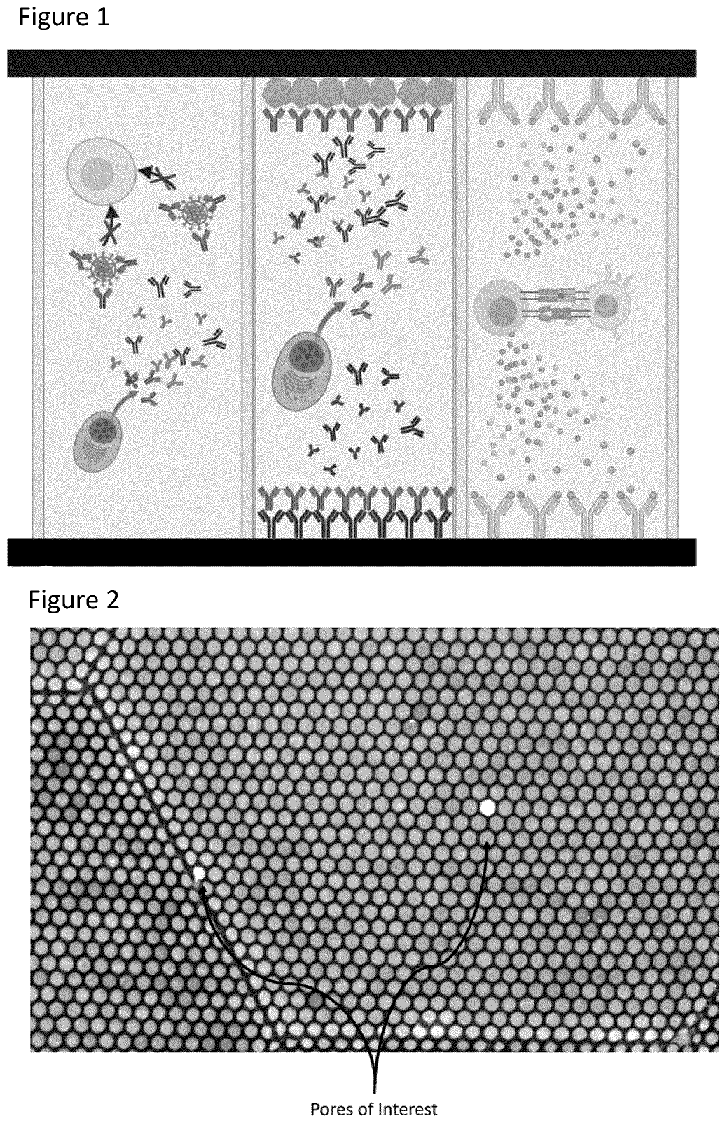

As previously mentioned, microcapillary-based assays provide options for high-density and high-throughput analysis, useful in antibody discovery and other aims, especially where heterogeneous populations of cells are to be screened for particular characteristics. FIG. 1 shows an illustration of options of biological recognition assays that can be performed within micropores. From left to right, this figure illustrates an ‘in solution’ binding assay for an antibody-producing cell; a dual recognition assay where the product of an antibody-producing cell is screened for its interaction with an antigen (upper) and the binding of its heavy chain constant region to another antibody (lower); and a dual antibody-based assay to detect the secretion of one or more substances from a cultured cell. The microcapillary arrays in the illustrations are contacted to a sealing substrate, which may be coated with a binding partner (right-hand two examples) selected to interact with the product of a cultured cell.

Such assays can identify desired characteristics in a cultured cell, or more usually, the well of a microcapillary array containing a cell or other contents with desired characteristics. This identification is typically carried out by analysis of images of the microcapillary array itself, or of substrates contacted with the microcapillary array while the assay is carried out, which substrates may be associated with a binding partner designed to detect a substance within the wells of the target array. As an example, FIG. 2 shows a scanned image of a PDMS substrate resulting from an assay performed using a microcapillary array. The highlighted bright pores are a result of biological expression of a particular substance from those particular capillaries. The remaining capillaries illustrate the standard background signal from all pores.

The present invention provides improved methods for recovery of the contents of specific wells within a microcapillary array.

### Image Analysis and Target Identification

For the identification of a target well for recovery, it is often necessary to determine the properties of the contents of the target well before the steps of recovery take place. As above, this often involves determining the outcome of an assay performed within the microcapillary array, and may involve determining an interaction between a product of cultured cell within the array and a binding partner. Such an interaction may occur within the microarray well itself (an ‘in solution’ assay), and the outcome of such assays can be detected in ways known in the art. Split-GFP interactions or Fluorescence Resonance Energy Transfer (FRET) effects are examples of interactions which can be detected by fluorescence or other imaging of a microcapillary array after an ‘in solution’ assay. Also relevant are ‘bead-based’ assays, for example, those where fluorescently-labelled and antibody-coated beads are used to measure and detect analytes of interest.

Surface assays can also be used, for example where one or more binding agents are immobilised on the surface of a substrate which is reversibly contacted to the microcapillary array during an assay such that the substrate surface is exposed to the contents of the array, and subsequently removed and assessed for the presence of an interaction, for example by intrinsic fluorescence or visibility, or by use of a further detection assay such as immunohistochemistry or in-situ hybridisation. Suitable possibilities for substrates enabling useful assays can be readily conceived. The substrates may comprise silicon, and/or may be a polymer. The substrate may be gas-permeable, and may comprise poly(dimethylsiloxane) (PDMS). In one embodiment, the substrate comprises glass, and/or quartz. In embodiments, the solid substrate is degassed and the substrate is a gas permeable material. The substrate may be treated with oxygen plasma to reduce hydrophobicity, for example by introducing polar functional groups. In another embodiment, the substrate is coated with an agent such as vinyl silane or aminopropyltriethoxy silane (APTES), which may be useful to allow attachment of the solid substrate (for example, glass) to the at least one binding partner.

In the present context, multiple different concurrent assays can advantageously be enabled, for example, by sealing a substrate to each side of the microcapillary array, and/or by carrying out one or more surface assays and one or more in-solution assays together. In any case, the result of the assays is typically one or more images of the microcapillary array and/or of a substrate, with signals at locations corresponding to particular wells of the microcapillary array.

Accordingly, image analysis processes may be relevant in embodiments of the invention, as without an accurate and efficient image analysis step, it would be difficult to determine which wells should be targeted for material recovery in an array. For example, it may be necessary to determine which wells of the microarray contain B cells secreting the most effective neutralising antibodies, and then to output the position of the selected pores for use as input for the controller of the components of the present invention.

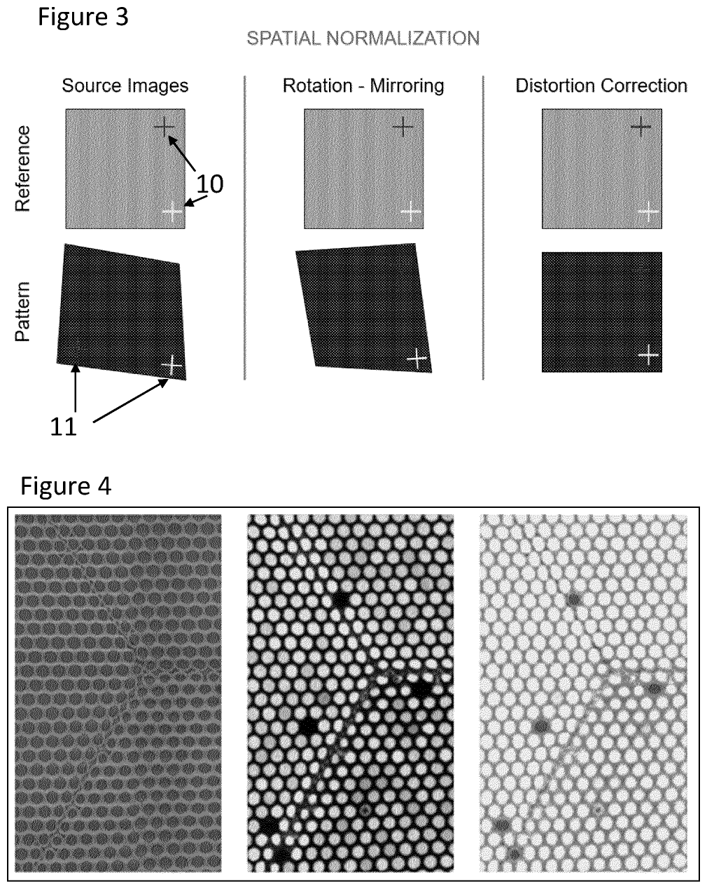

In particular where surface assays are used and image analysis of a substrate is required, there may be distortion and orientation differences between the substrate and the corresponding microcapillary array. For instance, PDMS as a substrate material is flexible and can be stretched or otherwise deformed during processing. Its image may therefore not be a perfect spatial representation of the physical array, making it difficult to then target the correct pore for recovery. Image analysis processes therefore suitably include spatial normalisation steps in order to map the substrate image (pattern) to a reference image that is a perfect spatial representation of the array, as shown in FIG. 3. Spatial normalisation steps include rotation and mirroring, and distortion correction, until there is alignment between the pores on each image. Suitably, the microcapillary array will include reference areas or markings (10), which are then transferred to the pattern image (11), and are affected by any distortion, such that correction of the images of the known reference areas will mean that the images are normalised. Superimposition of the pattern and reference images can be used to determine success of alignment, as shown in FIG. 4, which shows (left to right) a Reference image-Pattern image-Pattern image superimposed on Reference Image. Similarly, when multiple parallel assays are carried out, alignment and superimposition of assay images can identify target wells with positive results from each assay.

Once alignment is complete, selection of target wells can be achieved manually, or automatically by computer analysis. In some embodiments, areas of highest image intensity and/or co-incidence of signal from multiple images denote desired target wells. Pseudo-colourisation can be used to identify areas of high or co-incident signal for ease of manual selection. Computer-controlled algorithms can also be used to automatically identify wells meeting particular criteria.

### Liquid-liquid Recovery

Previous approaches, such as those described in WO2012007537A1, describe isolation of contents from specific microcapillaries in an array by ablating a hole above the target microcapillary in a sealant covering the microcapillary array followed by the application of a flow of gas, specifically, nitrogen gas to the ablated hole. The gas flow causes the contents of the microcapillary array, in the above reference amounting to approximately 1.2 nL, to be ejected. While this approach can lead to the recovery of viable cells, it is an open system with the 1.2 nL contents of the microcapillary blown into an open receptacle plate. For applications that require absolute sterility, such as clinical cell therapy manufacturing or discovery workflow, a closed system may be preferable.

Without wishing to be bound by theory, it is thought that under such air pressure-based recovery conditions, when the liquid is ejected by the flow of gas and leaves the microcapillary at high speed, it is subject to some degree of evaporation, especially due to the very small volumes inherent in using microcapillary arrays, that could result in some loss of the contents to be recovered. It is also considered that surface tension on the underside of an array can be significant, and can cause the contents to spread along the underside of the array (the side opposite the source of gas), for instance if the air pressure is not high enough to expel the liquid in one fluid motion. Such approaches are also open systems that could result in loss of sterility, which is a problem for potential applications such as personalised cell therapy development. Similar concerns exist for other recovery approaches such as using a laser to heat magnetic particles to eject liquid contents of a microcapillary array, which also typically result in the death of cells and/or damage to microcapillary contents. While such approaches still have their uses, for example, in DNA recovery from killed cells, these drawbacks limit the application of microcapillary array-based methods for in situ viable cell recovery for cell therapy manufacturing.

The present inventors have developed systems and methods which eliminate evaporation and ensure substantially full recovery of the contents of the target microcapillary, while maintaining a closed loop approach for sterility and use in cell therapy manufacturing workflows.

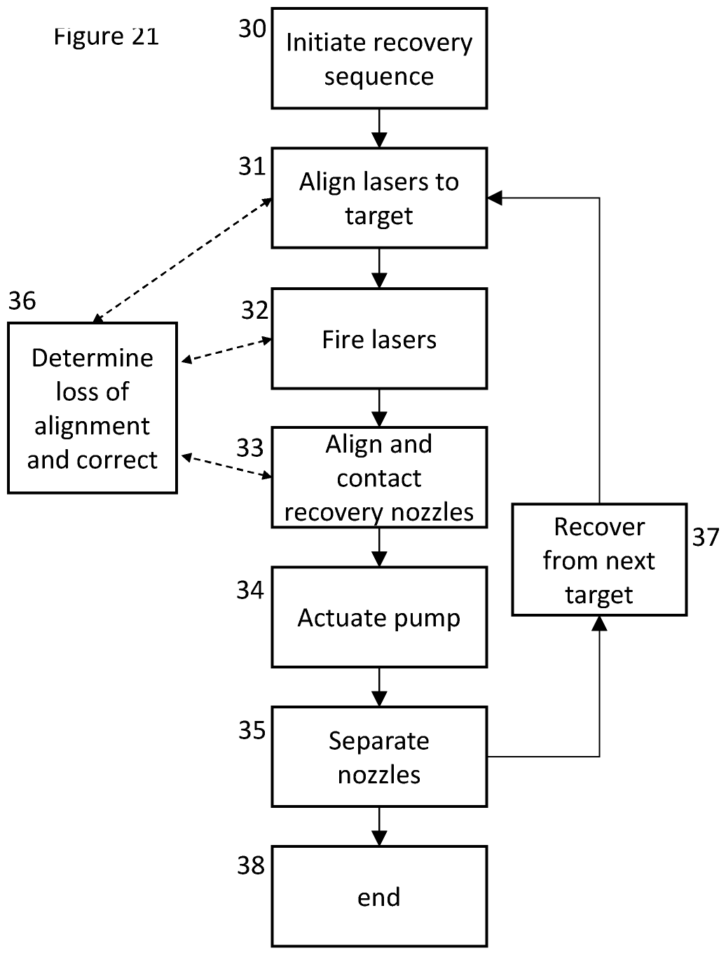

The present approach uses liquid-liquid recovery to achieve these benefits. An example of the steps involved in a liquid-liquid recovery process is shown in FIG. 21, as further discussed below. In particular, at least one recovery duct is placed on one side or end of the target well, aligned with an opening of the target well, and brought into contact with the opening, in order to bring it into fluid communication with the contents of the target well, and form a continuous channel through which liquid can flow without significant leakage. Recovery then occurs by a flow of a liquid between the one or more recovery ducts and the target well, such that the contents of the target well are maintained within a liquid environment throughout the recovery process. This flow can be in either direction, either into or out of a recovery duct, as described in more detail below. For this reason, the terms ‘duct’ and ‘nozzle’ are used interchangeably herein in this context, such that the term ‘nozzle’ is not intended to imply a structure capable only of expelling fluid. In some embodiments, a recovery nozzle is coupled to a source of liquid, which is used in the recovery process to contact the contents of the target microcapillary and to remove the contents by liquid flow. In some embodiments, where the contents of the target well are taken into a recovery nozzle, the recovery nozzle may be coupled to a collection vessel.

While the recovery processes described herein typically use a flow of liquid in order to recover the contents of a target well, with benefits of doing so as discussed, it is considered and envisioned herein that similar processes can be carried out using a flow of other fluid, for example, a flow of a gas. Accordingly, discussion herein of liquid-liquid recovery, flows and sources of liquid and the like are considered to also apply to other fluids. In the present context, it is considered that similar benefits to using a liquid-liquid recovery system, for example, higher success in isolating viable cells, especially relatively fragile mammalian cells, may also be achieved using a flow of gas at relatively low flow rates, and/or by using a flow of gas with high humidity. Such approaches, especially in combination with the closed system described in some embodiments herein, may also be effective in reducing evaporation and stress on cells for recovery.

The flow of liquid is driven by any suitable means, typically, by a source of pressure (also referred to as a flow generator) such as a pump, in order to create a pressure differential between the recovery nozzle and the contents of the target well. Such pressure can be positive (blowing or forcing liquid out of a recovery nozzle into an opening of the target well and out of another opening of the target well) and/or negative (sucking or drawing liquid from the target well into a recovery nozzle). Pressure sources (117) can comprise one or more pumps, with suitable pumps including pressure pumps, syringe pumps and peristaltic pumps, for example. The pressure sources can be coupled to the inflow to and/or the outflow from the target well.

Typically, two recovery nozzles are used, that is, a first and second recovery nozzle are aligned with and contacted respectively to first and second openings of the at least one target well. Liquid then flows from the first recovery nozzle through the at least one target well and into the second recovery nozzle, such that the contents of the at least one target well are taken up into the second recovery nozzle. The advantages of this approach are the reduction of potential points of loss of cellular contents, and the improved well specificity given by the alignment of the two nozzles on each respective opening of the target well. It can be appreciated that the flow of liquid can be in either direction between the first and second recovery nozzles, which can allow contents of different target wells to be collected separately, for example where those target wells have been identified as having different properties.

Nevertheless, it is also contemplated that liquid-liquid recovery can be achieved using only one recovery nozzle. For example, a recovery nozzle can be aligned with and contacted to an opening of a target well and flow liquid into the target well, whereupon the contents are ejected from another opening of the target well and collected, typically wherein the contents fall from the underside of a horizontally-oriented microcapillary array. In some embodiments, a recovery nozzle can be aligned with and contacted to an opening of a target well and take up liquid from the target well by negative pressure. In such cases, it may be helpful for an amount of liquid flow to occur initially from the recovery nozzle into the target well before the liquid is taken up, to ensure contact between the liquid within the recovery nozzle and the contents of the target well.

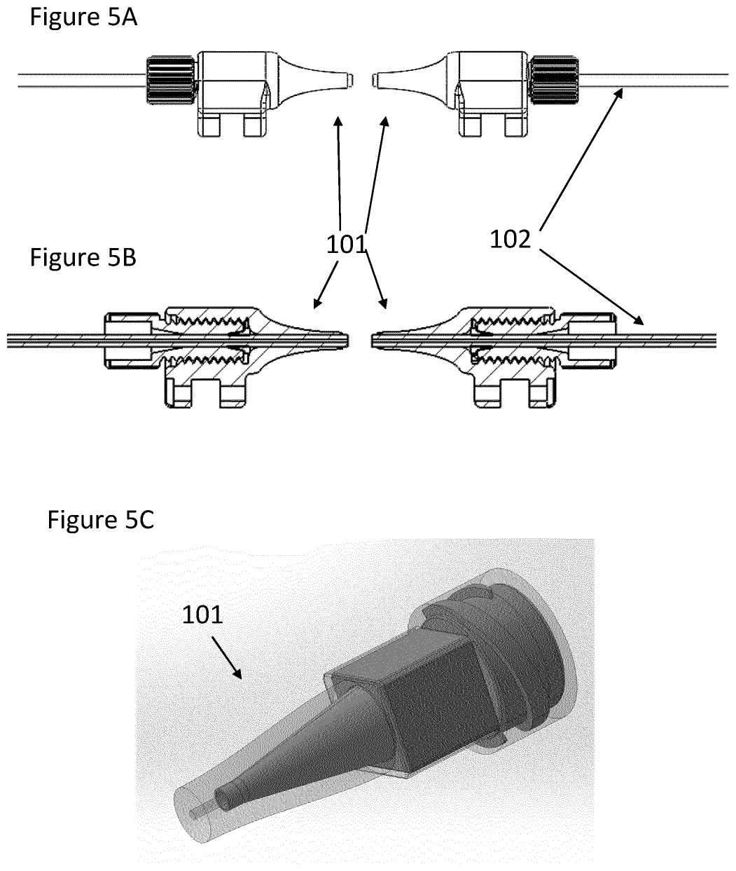

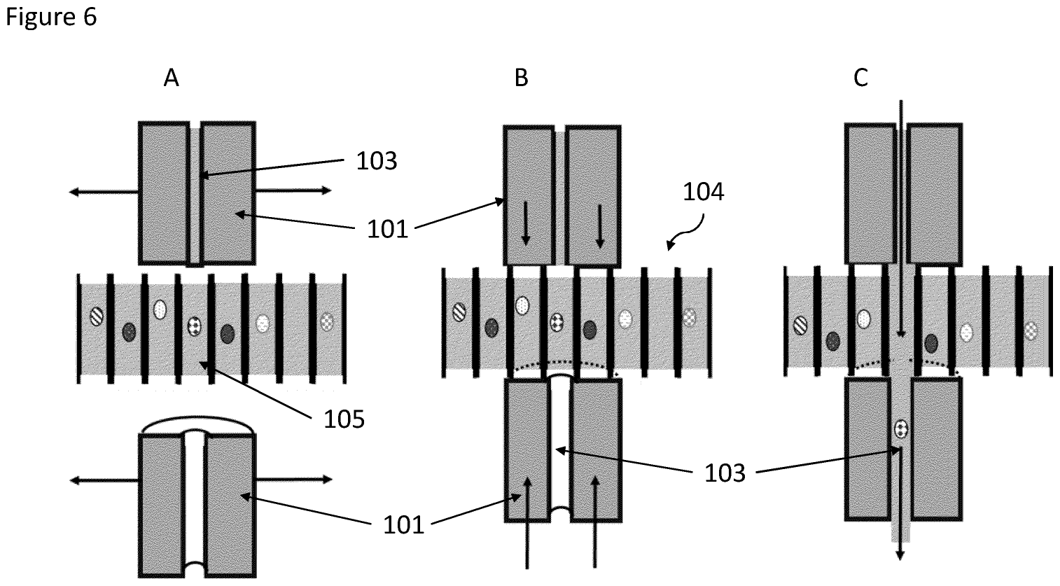

In the present context, the recovery ducts or nozzles are any means that can accurately direct and/or receive fluid, being a liquid or a gas, to or from the target well. An example illustration of two recovery nozzles and a longitudinal sectional view thereof can be seen in FIG. 5A and B, while a cross-section view of an example liquid-liquid recovery process can be seen in FIG. 6 A, B and C. The recovery nozzles (or ducts) (101) used can be made of any suitable material, and can be in the form, for example, of a needle, thin tube or a single microcapillary, which can be sealed into solid glass or a similar structure, such that there is an opening that can be aligned to a target well (105). In some embodiments, the recovery nozzles are themselves microcapillaries or microtubing, and can be made by similar methods to those used to prepare microcapillaries. In some embodiments, the recovery nozzles are coupled to tubes (102) or similar structures which can convey the recovered well contents to a collection vessel. The recovery nozzles can comprise a bundle of structures, such as a bundle of individual microcapillaries, which can allow for recovery from multiple target wells at once.

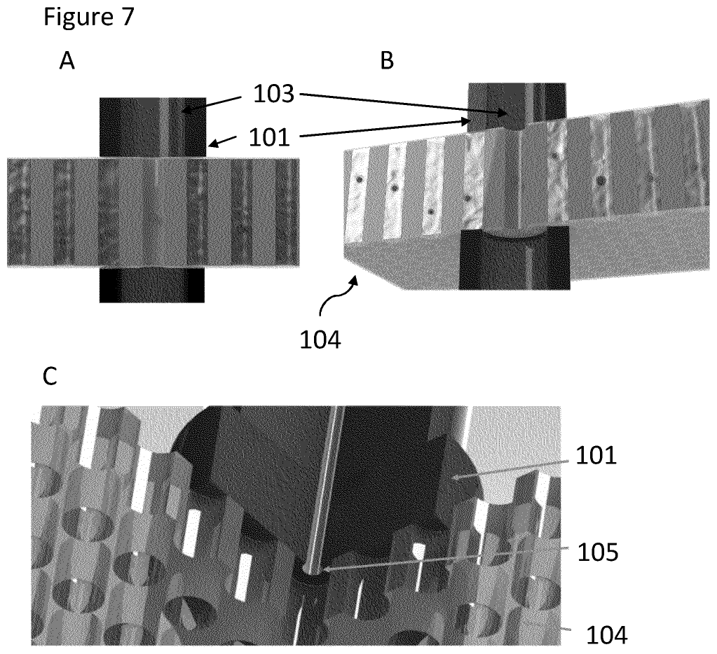

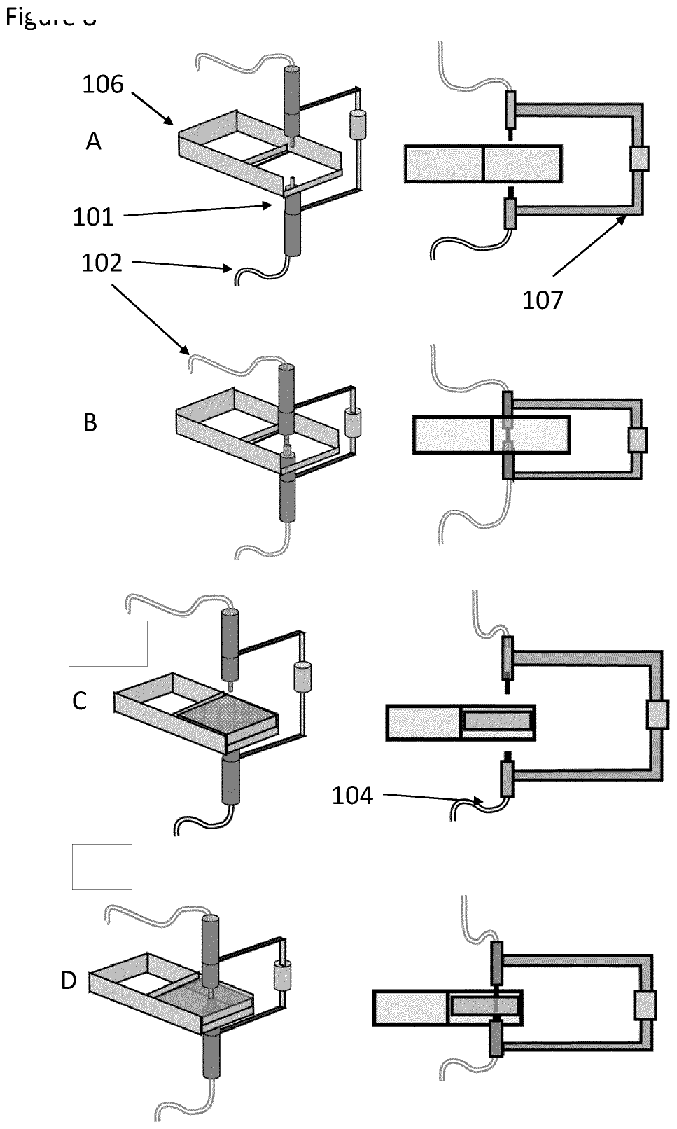

The recovery ducts or nozzles themselves typically have a tubular structure, comprising a bore or lumen (103) through which liquid can flow, and a surround which is liquid impermeable. The diameter of the nozzles used can vary but are selected such that an effective seal can be made between the nozzle and the target well (105). Given that an aim of the present methods and systems is to recover only the contents of the target well, it may be advantageous for the diameter of the lumen to be no greater than the diameter of the target well (105), and preferably smaller than this, to avoid creating liquid flow into neighbouring wells and hence recovery of non-target contents. In such cases and others, it may also be advantageous for the surround of the nozzle to have a wide diameter, in other words to be thick-walled, in order to block the openings of surrounding wells in the array (104). Such approaches can be seen in FIGS. 6 and 7C.

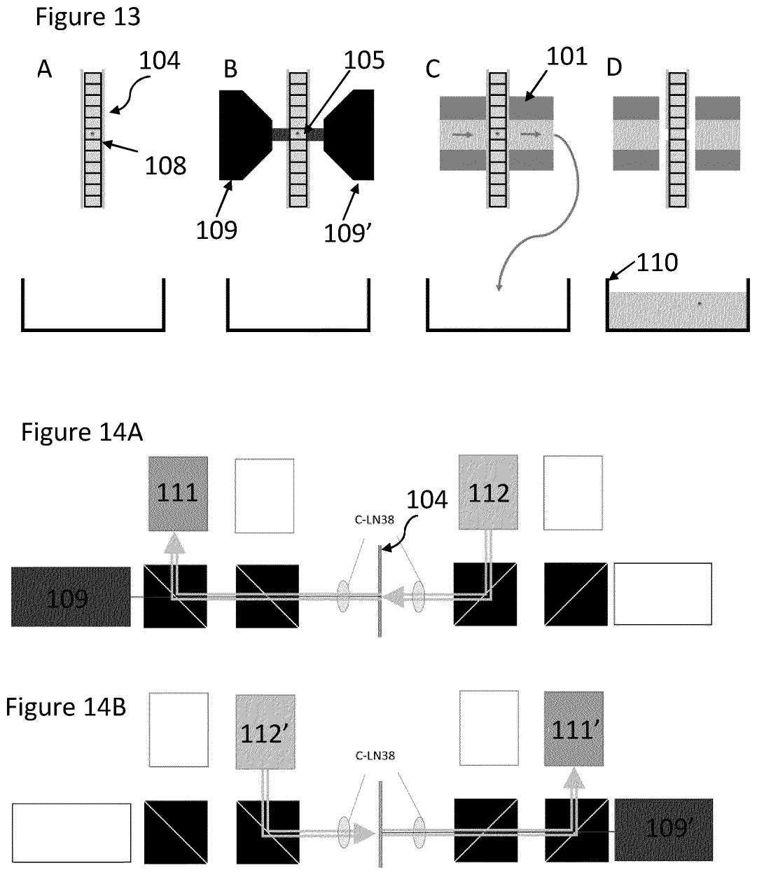

However, it is not essential for the recovery nozzles to have a narrower lumen than the target well for recovery, and in some embodiments the lumen can be wider than that of the target well, for example, in embodiments where the openings of non-target wells are sealed, as described elsewhere herein. In such cases, it is not deleterious for the lumen of the recovery nozzle to cover, embrace or enclose the openings of multiple wells. Such approaches can also be advantageous in increasing the potential flow rate and improved flow patterns in the target well. Additionally, alignment of the recovery nozzles does not have to be so precise in such configurations, as specificity is driven or assured by the apertures made in the sealing materials used. An example of such an approach can be seen in FIG. 13.

Where the lumen diameter of the recovery nozzle is different to that of the target well to which it is aligned (or to another aligned nozzle), it may be advantageous for the lumen of the ‘receiving’ volume, that is, the nozzle into which the contents of the target well is taken up, to be equal to or greater than the diameter of the target well, in order to reduce potential back pressure. Where two recovery nozzles are used, their diameters need not be the same, but again it may be advantageous for the nozzle from which liquid is flowed to have a smaller diameter than that of the target well and/or the diameter of the receiving nozzle, in order to reduce back pressure.

One or more of the recovery nozzles can suitably comprise a deformable tip or coating at the end of its surround, suitably comprising a synthetic or natural polymer or rubber material, to improve the seal between the nozzles and the periphery of the target well on contact and thereby reduce leakage. Pressure-activated valves can also be used, such that flow does not occur until a certain amount of force is enacted by the nozzle on its target. It is useful, however, for the nozzle structure to have a certain structural rigidity overall, such that it can be easily positioned and a sealing force can be developed against a target, without excessive impact on the shape or position of the nozzle.

In this regard, in some embodiments, for example as seen in FIG. 5B, the recovery nozzle can take the form of a tube (for example, a tube comprising silicone) extending through and held in place by one or more housings, in FIG. 5B shown as a tapering structure, which acts to direct and position the tube, connect it to positioning stages or other components, and provide rigidity, for example when applying sealing force. This can enable a malleable tube to create a suitable seal as discussed above, while being easily directed to a target location, and easily connected to further conveyance tubes (102), for example by the tube continuing seamlessly from the tip of the nozzle through the housing and onwards, as shown.

In some embodiments, for example as shown in FIG. 5C, a malleable material such as silicone (shown as a translucent cover) can be moulded around a relatively rigid nozzle structure (for example, comprising metal or polymer) so that that effective sealing can be aided by the malleability of the silicone as discussed, and the positioning and rigidity by the internal metal or plastic structure. This technique can also ensure the limitation of dead volume into the nozzle which could be caused, for example, by disparities between the diameters of the nozzle and other tubing. A tube can then be connected at the back of the nozzle with classic microfluidics connectors, or otherwise.

Where two recovery nozzles are used, they can be configured as discussed elsewhere herein such that they can be aligned and contacted not only to the target wells of the microcapillary array, but also to each other, for instance where the microcapillary array is not yet present. Such contact can allow for calibration of the respective positions of the nozzles, and liquid flow can be initiated and measured to monitor for leaks. An example of such a process is shown in FIGS. 8A to 8D. Each of these figures show perspective and side-on views of two recovery nozzles positioned in mutual opposition either side of a stage for a microcapillary array (106) and connected to a stage allowing relative movement in the Z direction (107). These nozzles can be contacted to each other (A, B), or when a microcapillary array (104) is in place can be contacted to a target well in the array (C, D). When the nozzles are brought into mutual contact, a flow of liquid from one nozzle to the other is permitted. The microcapillary array stage may be coupled to an XY stage (118) and positioned between the two recovery nozzles. When the nozzles are aligned and brought into contact with a target microcapillary in the microcapillary array, a continuous flow of liquid from one nozzle to the other through the target microcapillary is permitted.

During the processes described herein, for efficacy of the liquid-liquid transfer process, it is important to create specific and secure communication between the recovery nozzles and the target microcapillary well. Contact pressure between the recovery nozzles and the target well must be sufficiently strong to ensure that fluid transfer can occur without significant leakage, but also while avoiding damage to the microcapillary array or disruption of non-target wells.

To enable detection and control of contact pressure, in some embodiments, force feedback devices are included in the system. Force feedback devices such as miniature strain gauges or Wheatstone bridges can be used to determine force readings that are used as an input of a real-time controller. The function of the controller is precisely to control the force level applied to the contacting area between nozzle and a microcapillary array. A predefined, prelimited force level can be determined and applied, allowing a liquid-liquid recovery to be accomplished while avoiding liquid leakage and array damage. A protocol for determining and applying the force value to be applied, which may be implemented by an electronic or other controller may include outputting from a strain gauge associated with one or more nozzles information on a contacting force. The controller compares the input force value to a set point, and outputs an appropriate control signal to a positioning stage of one or more nozzles, or to the microarray stage. This control signal is converted into stage displacement movement, which can control movement of the nozzle or nozzles relative to the array surface.

In some embodiments, one or both of the openings of the wells of the microcapillary array are covered or sealed by a barrier such as a web, a layer, a cap or a plug. The barrier could be continuous across a plurality of wells or discontinuous, such as an array of discrete caps or plugs each aligned with a respective well or group of wells. Typically, an aperture must then be created in the barrier or otherwise positioned in a location corresponding to the opening or openings of the target well, so that recovery can take place. Such approaches have the effect of improving specificity, by reducing the likelihood of recovery from wells other than the target. Other effects include reducing evaporation, accidental loss of or damage to contents from the microcapillary array. In some embodiments, the covering is achieved by use of a mask or plate, which may be movable, and may comprise a permanent aperture. The mask or plate can be moved (in the XY direction) to align the aperture to the opening of the target well.

In some embodiments, a sealing film is applied to the microcapillary array before recovery takes place, that is, before recovery nozzles are contacted to the openings of the target well. Such a sealing film typically covers the openings of at least one, typically most or all, of the well openings on one side of the microcapillary array. In some embodiments, such sealing films are applied to both sides of the microcapillary array, thereby covering both of the mutually-opposed openings of at least one well.

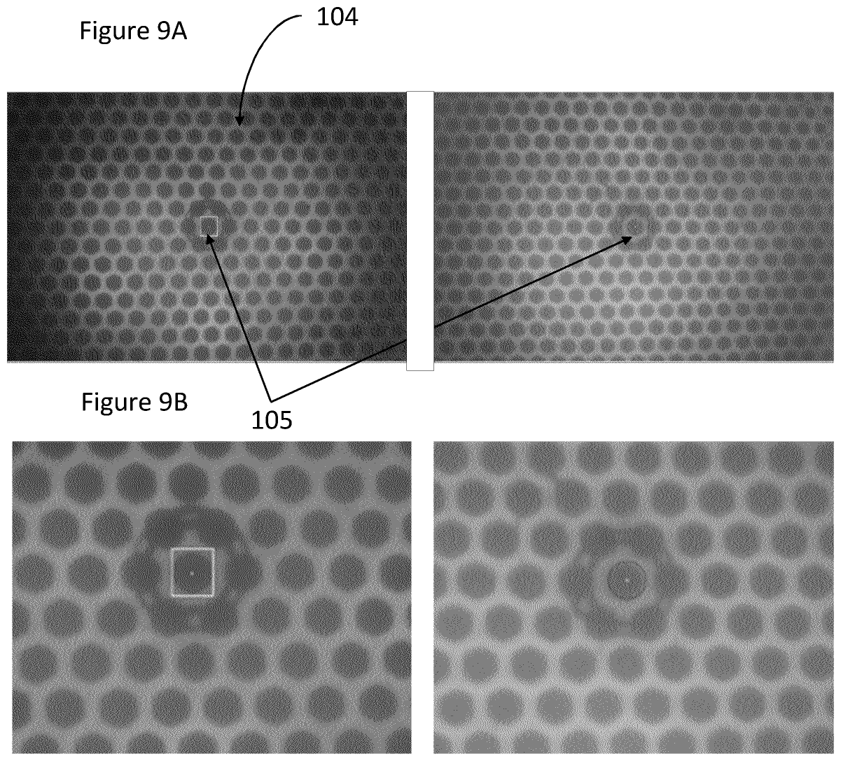

Sealing films, as discussed herein, are any sheet or web of material capable of forming a seal (whether alone or with the use of an adhesive) with the openings of a microcapillary array. Advantageously, these films may be susceptible to penetration by a penetrator or other aperture-creating device or means as discussed elsewhere herein, for example, a low energy laser, thereby creating an aperture of a size comparable to that of a microcapillary well (for example, between 5-500 μm in diameter). FIG. 9 shows views of opposite sides of a microcapillary array covered on each side with a polymeric film, with an aperture made in the sealing film by a laser over a target well.

Sealing films are typically polymeric films, which may be selected from the group including but not limited to polylactide, polygalactide, polypropylene, polybutylene, PET, polycaprone, polyester, cellophane and any combination thereof. Such films may be coupled with a suitable adhesive, including but not limited to acrylic-based adhesives, pressure-sensitive adhesives, and so on. Adhesive-backed cellophane or PET films have been found particularly advantageous. PET film, suitably approximately 2 μm thick, typically with a layer of acrylic adhesive of approximately 8 μm, has been found to have particularly suitable properties, for example, smaller laser ablation diameters and a smaller affected area.

### Components

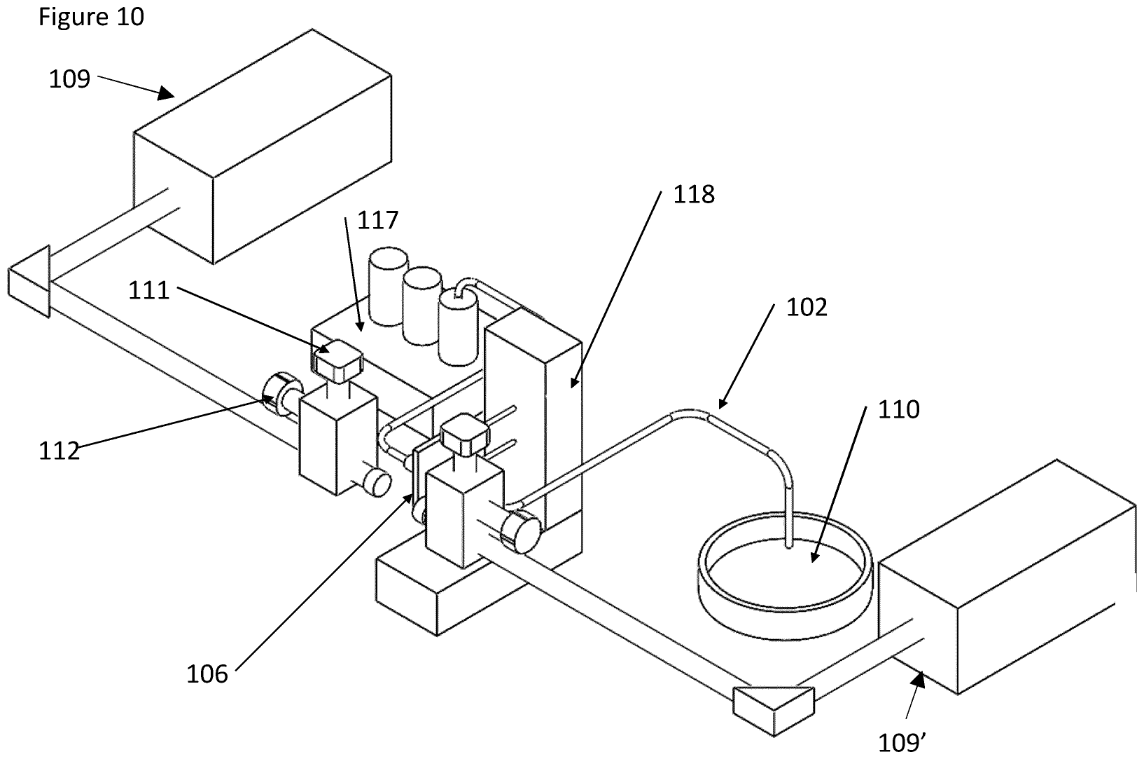

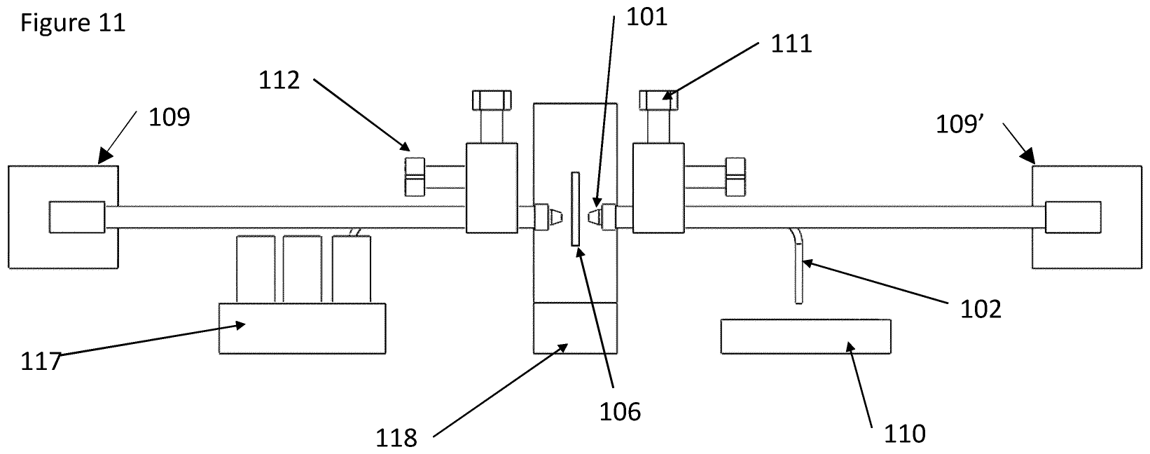

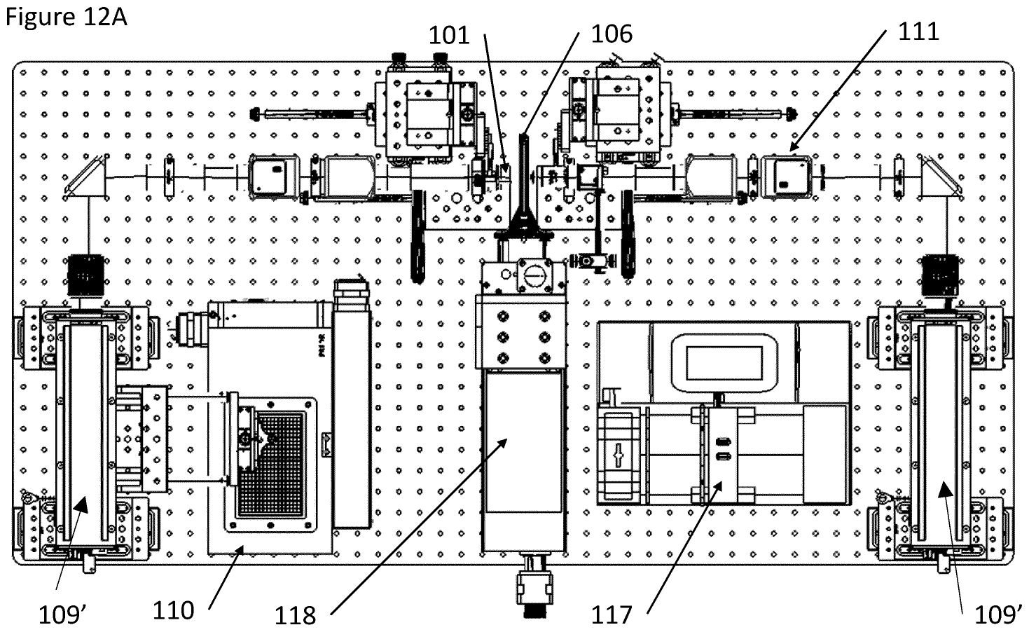

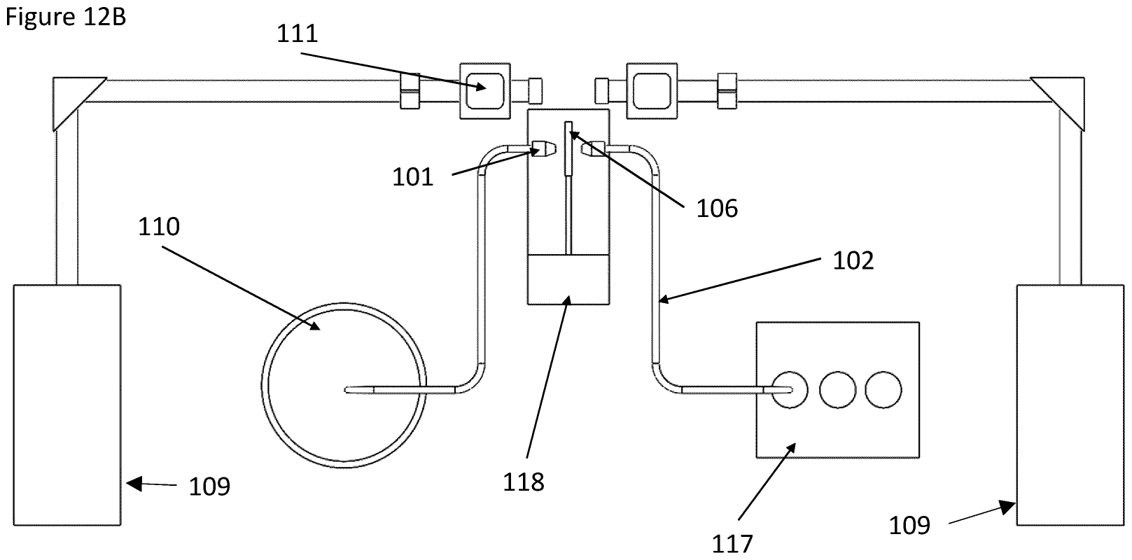

While, in principle, the methods of this invention could be carried out manually, with a user aligning and contacting one or more recovery nozzles to a target well of a microcapillary array, given the precision required, it is likely that an integrated and at least partially automated system will be used in practice. Examples of systems can be seen in FIGS. 10 to 12. These show different views (respectively perspective, side-on and top-down views) of a simplified example recovery system comprising microcapillary arrays (106) positioning stages (118), penetrators/lasers (109, 109′), recovery ducts/nozzles (101) and tubes (102), illumination (112) and camera systems (111), optical platforms, fluid flow devices (117), and collection plates (110). FIG. 12A shows a top-down view of an exemplary system with the components shown closer to scale, with FIG. 12B showing this in simplified form.

As demonstrated in various Figures, the orientation of the components of the invention can vary, for example, the microarray can be positioned in vertical or horizontal orientation, hence extending in substantially vertical or horizontal planes. In this context, the directions X and Y relate unless otherwise stated to movement across the surface or a major face of a microarray plate, that is, between one well and another. The Z direction therefore relates to movement towards or away from that face of the microarray. Thus, a recovery nozzle may move in the XY direction to align with a particular target well, and in the Z direction to contact (or to break contact with) a well.

Any of the components as described herein can, where appropriate, be configured to be movable in the XY and/or Z directions. In some embodiments of the invention, the recovery nozzle or nozzles are aligned with and contacted to a particular target well in order for liquid flow and content recovery to be achieved. Similarly, in some embodiments it is necessary for one or more lasers or other penetrators to be aligned with and create an aperture in a barrier or otherwise to remove the barrier material at a location corresponding to a particular target well. For example, therefore, the recovery nozzle or nozzles, the lasers or other penetrators, and/or the microcapillary array are configured to be movable in the XY and/or Z directions. The skilled person will recognise that movements of various components relative to each other can be achieved in various ways, such that references herein to a first component being moved or movable relative to a second component can be accomplished by movement of the first and/or second component, one of those components being fixed, or either or both of those components being movable.

In some embodiments, particularly wherein the system is automated, components are coupled where necessary to positioning stages, for example, high-precision XY stages, which can be moved with sub-micrometre precision in the XY direction. Similarly, components can be coupled to positioning stages mobile in the Z direction.

In some instances, it may be advantageous to restrict the movement of various components, for example by mounting them on stationary stages, or stages only able to move in the XY or the Z directions. Similarly, once in a desired position, movement can be disabled in one or more directions. This can be useful for keeping highly precise elements such as laser and mirrors stationary, as micron precision laser focusing is required. Such restrictions make the system more robust. In some cases, one of the recovery nozzles could be kept stationary, to reduce the number of moving parts which need to be controlled and aligned, and thereby reduce complexity and software steps.

Penetrators or aperture-creating means: In some embodiments, the openings of the microcapillary well are sealed with a sealing film or other barrier, and an aperture is made in the sealing film at a location corresponding to an opening of a target well before recovery. In such cases, the aperture may be made by any suitable means or approach that penetrates or removes or otherwise circumvents the barrier. For example, the sealing film can be pierced with a needle or similar implement, or cut with a blade or cutter, for example a circular cutter to break through a circumference of the film at a target location. An electrode or heating element can be used to melt through the film at a target location to create an aperture. In some embodiments the sealing film itself is adapted to facilitate the creation of an aperture, for example, including perforation, areas of reduced thickness, and/or areas of different materials. The film can comprise materials which respond to various stimuli, such as ultrasound or electromagnetic radiation, by melting or otherwise forming an aperture. In such cases, a source of such stimuli, such as an ultrasound emitter, or a laser or other electromagnetic radiation producer, may be used as a penetrator or aperture-creating means.

Where a microcapillary array is sealed on both sides, the creation of an aperture on both ends of a target well may require that a penetrator is present on both sides of the microcapillary array, and/or that a penetrator is movable between the two sides of the microcapillary array, and/or that the microcapillary array is turned to present both sides to a penetrator in succession.

Creation of an aperture at a location corresponding to a target well will require the penetrator and the microcapillary array to be movable in the XY direction relative to each other. Where aperture creation requires contact between the penetrator and the sealing film, the penetrator and the microcapillary array can be movable in the Z direction relative to each other. To aid in accurate positioning, one or more cameras may be used to monitor the position of the penetrator and/or its target. Such a camera may be movable with the penetrator, or may be separated from the penetrator. In some embodiments, the penetrator may be integrated with a recovery nozzle, which can be advantageous since the target well for both components is generally the same, reducing the number of alignment motions necessary.

Preferably, the aperture is created in a way that minimises disruption to any contents of the target well, such as might be caused by changes in pressure or temperature to any liquid contents of the target wells. Additionally, the diameter of the aperture created in the barrier or by removal of the barrier is preferably close to the diameter of the opening of the target well, to avoid uncovering the adjacent openings of neighbouring wells, while still allowing sufficient access for successful recovery from the target well. In instances where recovery takes place from multiple target wells, all the appropriate apertures may be created before any recovery steps take place, or the apertures may be created between each recovery step, as preferred.

In some embodiments, the penetrator is or comprises a light-emitting means, typically a laser, which can create an aperture by absorption of energy at a target position on the sealing film and subsequent melting or ablation of the film at the position. Such an approach is advantageous, because the energy can be focused at a particular depth, so the energy provided can be centred on the sealing film and any energy passing into the well itself can be limited, reducing the risk of damage to the material for recovery. The wavelength and intensity of lasers can be controlled and chosen to be absorbed maximally by the target film and minimally by other components of the system. Additionally, lasers and the like do not need to contact the sealing film directly, reducing possible disruption to the array and/or well contents, and contamination risk. FIG. 13 shows an illustration of a microcapillary array (104, side-on) sealed with a sealing film (108) on both sides and an identified target for recovery (A), a step of laser ablation in the film over the target well (105) using lasers (109, 109′) (B), liquid-liquid recovery (C), and the successfully recovered contents located in a recovery well plate (110) (D).

A laser can be coupled with a camera, for example by a ‘through the lens’ (TTL) system where the camera (111, 111′) is incorporated into the optical path of the laser (109, 109′) (see FIGS. 14A and 14B), in order to allow a user to view the location and focal point of the laser. This can allow the determination of the XY position of the laser and its target, and of the Z position of the laser and its target (by the focal point of the camera, typically by calibrating the focal point of the camera to match the focal point of the laser). Accordingly, the laser and/or camera can be adjusted by moving the laser head in the Z plane to bring the sealing film into sharp focus. Alternatively, reflective means such as mirrors, suitably motorised mirrors, can be used to direct light energy to particular targets on the sealing film, reducing or avoiding the need to move the laser and/or the microcapillary array.

In some embodiments, the penetrator(s) and one or more recovery nozzle can be coupled together such that they are movable as a single unit. Such an arrangement can be advantageous in that it removes the need to calibrate and move the recovery nozzle(s) and the penetrator(s) to a target separately. However, in some embodiments it is preferred to keep these components separate, and independently movable, for example to avoid the presence of one component interfering with the function of another.

Where it is required to make apertures on each side of the microcapillary array, separate lasers can be used on each side, or a single laser can be used, for instance by use of reflective means to direct the light energy to the sealing film on each side of the array, by moving the microcapillary array itself such that the other side of the array faces the laser, or by changing the focal point of the laser to target the sealing film on the opposite side of the microcapillary array from the location of the laser itself. Alternatives to using a single laser include using multiple light sources positioned to coincide at a particular target point. Two-photon or multiphoton approaches as known in the art can be used in order to focus energy of a desired wavelength at a particular depth, that is, on the sealing film to be opened. Such approaches can allow for an improved ability to protect the contents of the microcapillary wells from the radiation required to create an aperture.

### Calibration and Optimisation

Given the possibilities of working at microscale enabled by the present invention, it is important that the components of the apparatus are calibrated accurately. For instance, the laser or other penetrator must be able to target the target well of the microarray identified by the screening, and to make an aperture in the sealing film at a location corresponding to the opening of the target well. Where sealing films are used on both sides of the microarray, this likewise applies to the laser or penetrator on both sides.

Similarly, the first and second recovery nozzle must be able to be aligned precisely to the location of the target well, so that fluid communication can be established. It can be appreciated that incorrect alignment of any of the components used by the present invention can lead to incorrect wells being targeted by the recovery nozzles, the loss of an effective seal being created between the volumes of the recovery nozzles and the target wells, the creation of apertures at locations other than those associated with the target well, and so on.

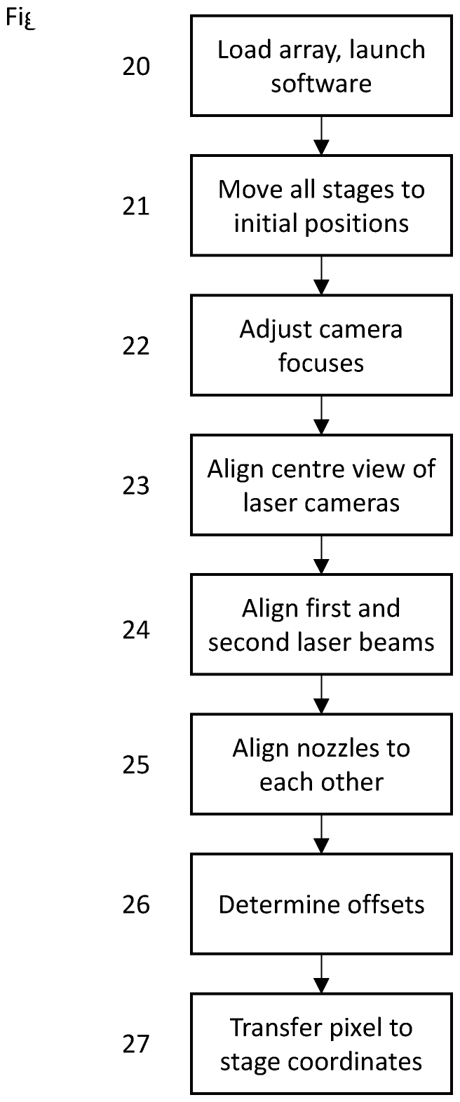

FIG. 15 shows a flowchart with an example of the steps involved in a calibration sequence according to some embodiments of the invention. It can be appreciated that not all of these steps must be completed in order, and that in some embodiments not all of the steps are necessary, depending on the features and components present. Briefly, the microarray is loaded into the array stage, and any recovery well plate is positioned to receive any recovered material. The controlling software is typically launched at this point (20). The stages holding each component as described elsewhere herein are moved to their initial positions, in order to define a repeatable initial state (21). The focuses of any cameras in the system (for example, the calibration camera, and/or the first and/or second laser cameras) are adjusted to be set on their target objective (22). The centre views of the first and/or second laser cameras are aligned (23), as are the laser beams themselves (24), to ensure that these are aiming at the same target, for instance, to the same single microarray well.

The recovery nozzles are aligned (25) such that when brought into contact with the microarray, fluid communication can be achieved between the nozzles and the contents of the target well. The location of alignment is saved for future recovery events, for example as Cartesian coordinates. An example of such an alignment step can be found in FIG. 16, as discussed below.

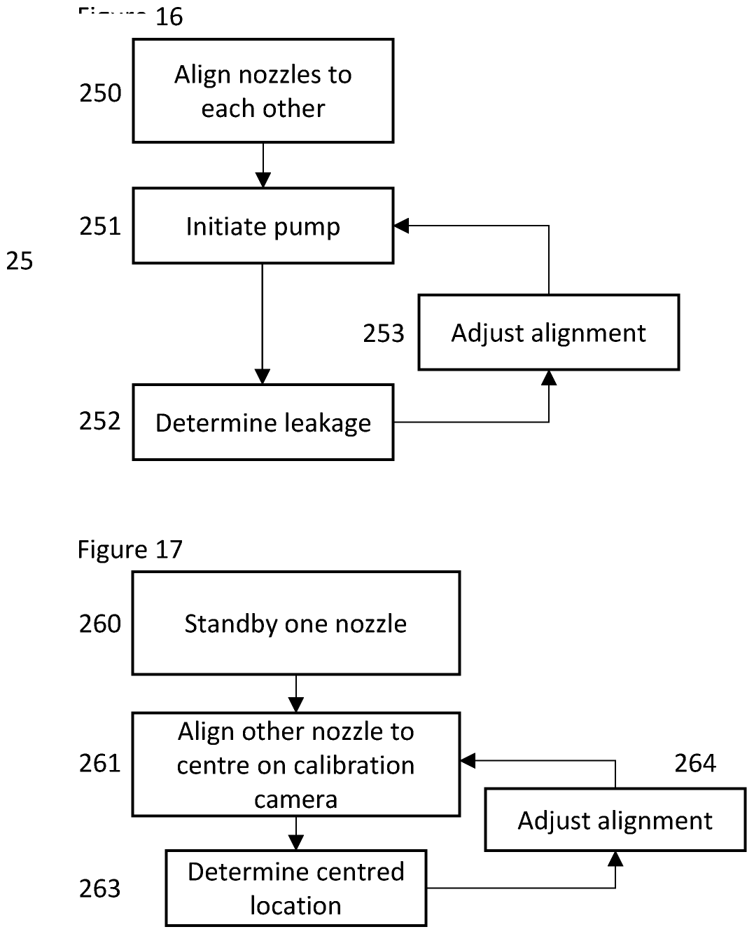

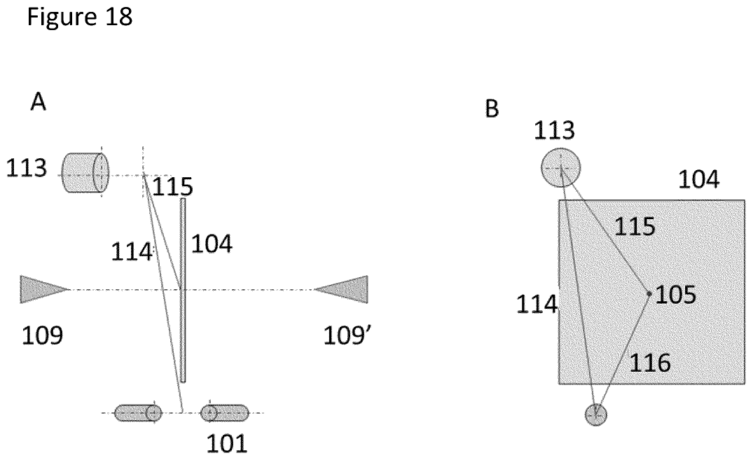

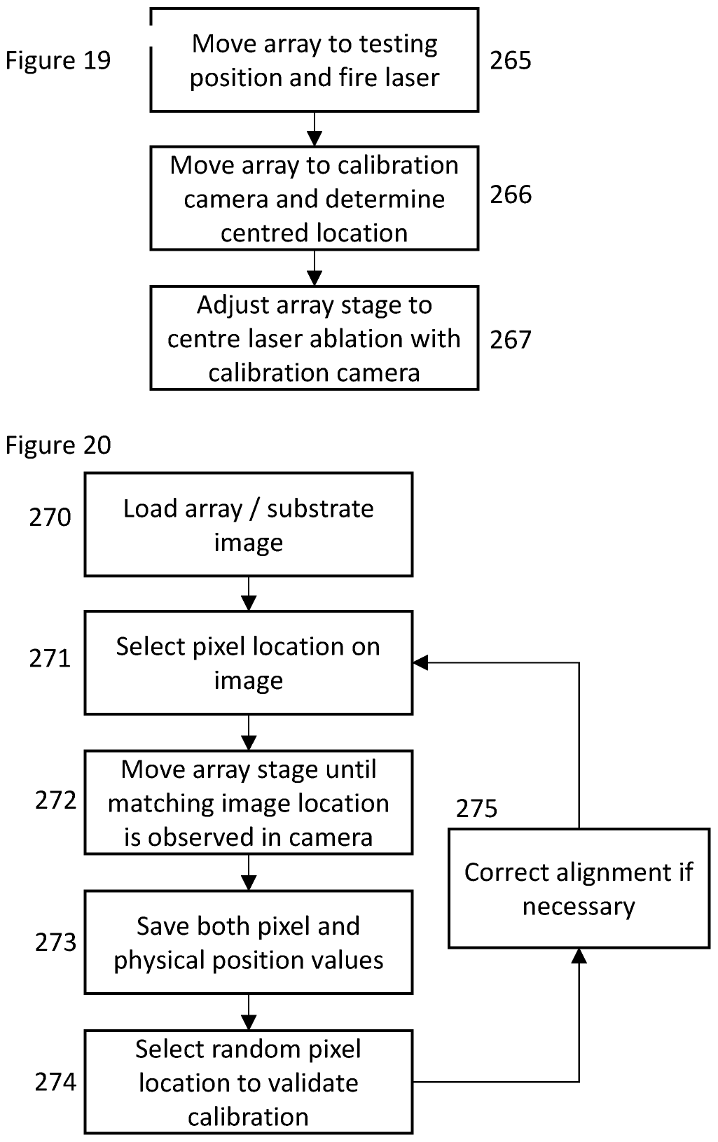

A step of determining the offsets of the components can be carried out (26). An example of the steps involved in such a process can be found in FIGS. 17 and 19, and an illustration of the positions and offsets determined in FIG. 18. Specifically, the objective of this step is to move the components relative to a calibration camera (113), in order to experimentally obtain one or more Nozzle-Camera Offsets (114) and Laser-Camera Offsets (115), from which can be derived one or more Laser-Nozzle Offsets (116). Such determination can allow calculation of the degree and direction of movement of each of the components in order to align them with a particular target (105) or site of laser ablation.

The location of one or more target wells for recovery is determined and transferred to the various stage controllers (27). The objective of this step is to convert pores of interest as detected in the assessed image, most likely identified in pixel units, to corresponding physical positions on the microarray to be targeted, for example, as demonstrated in FIG. 20. Suitably, where multiple target positions are identified, an optimisation step can be carried out in order to reduce the amount of movement necessary to visit each target well. The steps of recovery can then be performed, as described elsewhere.

Accurate calibration of the various components of the system can in principle mean that alignment of components during the recovery steps (for example, the alignment of penetrators and recovery nozzles to a target well) can be achieved without further monitoring of the positions of the components. However, for improved accuracy, it is often desirable to determine and update the positions of the components during the steps of alignment and contacting of the recovery nozzles to the target wells. This is typically achieved using cameras configured to detect and optimise the position of the components. Such cameras can be integrated with one or more of the other components, or may be separate. In instances where cameras are present on each side of the microcapillary array, they may monitor the position of the components on the opposing side. As an example, as described elsewhere herein, in some embodiments a camera is incorporated into the optical path of a laser used as a penetrator. This camera can be used to determine the position and target depth of the associated laser in real-time, and feed back to a control mechanism to make any corrections, such as adjusting focus, the position of the various stages, or adapting the calculation of any movements necessary to move to a particular location. It can also be used to monitor the real-time position of a recovery nozzle located on the opposing side of the microcapillary array as it approaches the target well, again feeding back so that any corrections can be made. As shown in FIG. 9, such an approach can also allow for visualisation of apertures made in a sealing film before recovery takes place.

In some embodiments, one or more calibration cameras are used, which are used as discussed elsewhere to ensure that the various components are present in the correct relative places, and that the movement of each of these occurs as expected.

These, and any other cameras, may benefit from an integrated or separate light source (112, 112′), which may be positioned as appropriate. For example, it may be useful to position a light source on the opposing side of the microcapillary array to aid vision through the array (see FIG. 14).

Nozzle alignment: FIG. 16 shows an example of the steps involved in aligning two recovery nozzles to each other during a calibration step, such as shown in FIGS. 8A and 8B. The nozzles are aligned to each other (250) and a pressure differential is established (251) such that liquid passes from one nozzle to the other. Any leakage can be determined by various methods such as monitoring pressure or liquid flow between source and recipient location (252). The alignment and/or contact pressure can be adjusted to correct this (253).

In FIG. 17, an example of the steps involved in calibration of the location of one or more recovery nozzles is shown, with further reference to FIG. 18. One nozzle may be held stationary (260) while the other is moved from its central location, aligned with the other nozzle, to centre on the calibration camera (261). The difference can be used to determine a nozzle-camera offset (114). Any amendments can be made if the movement to centre the nozzle on the camera does not result in the expected positioning (264).

Laser calibration: Similar methods can be used to ensure correct calibration of the lasers, or other penetrators, as shown in FIG. 19. The microcapillary array can be moved relative to the laser or lasers such that an example pore is targeted, and the laser or lasers are then fired to create an aperture (265). The location of the aperture and its centralisation on the target can then be determined by moving the array to the calibration camera (266), with any necessary amendment then made to the positioning of the array and/or the laser (267).

Location determination: Determining the location of the target wells for recovery and converting those into target positions for the various components is discussed herein. FIG. 20 shows an example of the steps involved in calibrating the position of a target location on a microcapillary array from an image pixel location so selected. The array or subject image is loaded into the controlling software (270), and a target location is selected on the image (271). The microcapillary array is moved relative to a camera, typically a camera associated with a laser or other penetrator, to confirm that the matching image location is observed (272) such that the relative movements are happening correctly. The position and pixel values are saved (273), for example as a ‘zero’ coordinate, from which can be calculated other positions. This process can be checked by selecting a random pixel location on the image and determining whether the appropriate movements are successfully made (274), making adjustments if necessary (275).

Recovery sequence: An example of the steps involved in a liquid-liquid recovery process as described throughout is summarised in FIG. 21. Once the microcapillary array is loaded, any preceding calibration steps are carried out, and a location of a target is selected, the recovery sequence is initiated (30). The lasers or other penetrators are aligned with the target well (31) by movement relative to the microcapillary array, if necessary, and one or more apertures are made (32) communicating with the target well. The recovery nozzles are aligned to the openings of the target well (33). Real-time monitoring of the alignment steps can be carried out as discussed above, with any corrections made (36). A pressure differential is created (34) in order to flow liquid through the target well and recover the contents. The nozzles are then separated from contact with the microcapillary array (35) and the process is repeated with a new target well, if necessary (37).

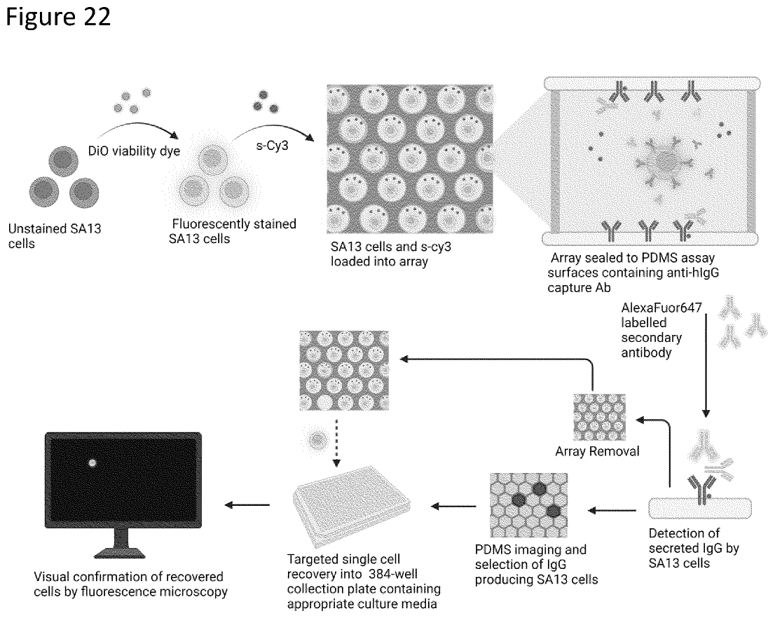

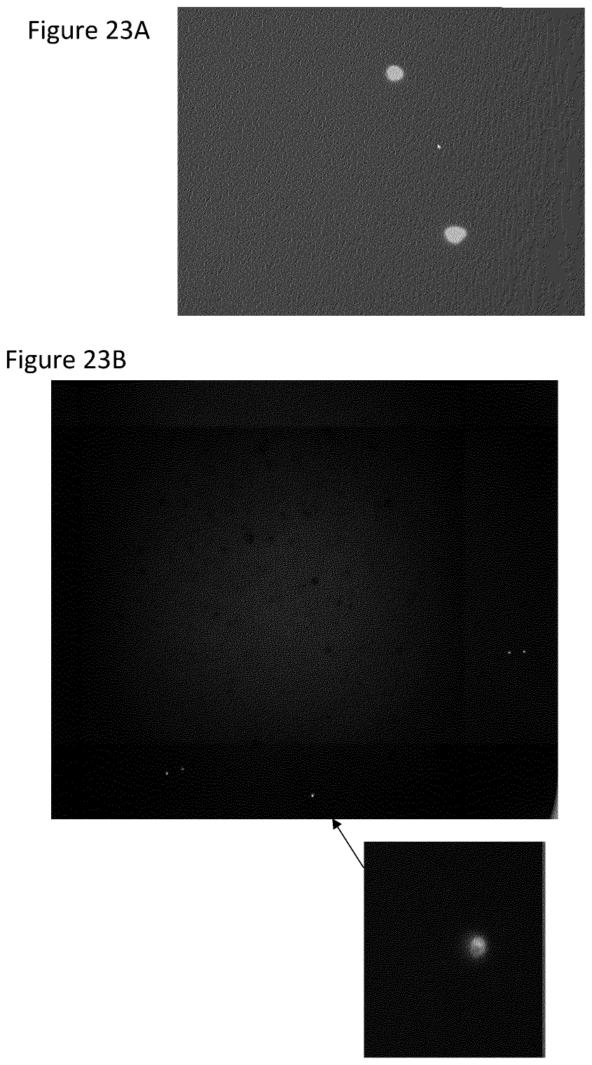

EXAMPLE—FIG. 22 shows a schematic of a recovery method using a system according to an embodiment of the present invention. FIGS. 23A and 23B show images of cells recovered using this method and system.

This experiment aimed to identify and isolate SA13 cells (a hybridoma cell line of human B lymphocytes) based on secretion of human IgG antibody. A PDMS slab was exposed to oxygen plasma, to clean and modify the surface, and reduce hydrophobicity, before being submerged in 3% APTES in ethanol solution for 1 hour at room temperature. The APTES-treated PDMS slab was cured overnight at 60° C.

Monoclonal mouse-anti-hIgG-biotin monoclonal antibody (10 μg/mL) was coated on to the PDMS surface. The surfaces were blocked with 3% Bovine Serum Albumin and degassed by placing the slab in a vacuum chamber consisting of a plastic desiccator connected to a vacuum tap for 1 hour.

SA13 cells were prepared at 1×10⁶ cells/ml, and stained with commercial DiO viability dye (5 μL) for 5 mins at room temperature. DiO stained SA13 cells were loaded into a microcapillary array at a density of 10⁴ cells/mL along with streptavidin-Cy3 (750 nanograms/mL in CO₂ independent media).

The microcapillary array thus loaded was placed on top of the PDMS substrate and pressed tightly to form a reversible liquid-tight seal. This was incubated overnight at 37° C. and at 5% CO₂. Upon removal of the PDMS surface from the microcapillary array, the released IgG from the SA13 cells was detected using monoclonal rabbit-anti-human IgG (250 nanograms/mL) as a secondary antibody for 1 hour at room temperature.

The PDMS assay surfaces are imaged at dual-wavelength using CY3 and CY5 channels for positive control (streptavidin-CY3) and IgG [analyte] (CY5) detection. Positive hits (lgG analyte producers) were selected using in-house Image analysis software and recovered into a 384-well target plate containing IMDM complete (+10% FBS, +Penn/Strep) media. Recovered cells were visualised under fluorescent microscope using the FITC channel. FIGS. 23A and 23B show images of recovered cells (two and five cells respectively) in the recovery well plates. The fluorescent dye used, and the shape of the recovered cells, indicated that the cells are viable.

This example shows that effective recovery at the single-cell level can be achieved after an assay is carried out.

Although particular embodiments of the invention have been disclosed herein in detail, this has been done by way of example and for the purposes of illustration only. The aforementioned embodiments are not intended to be limiting with respect to the scope of the appended claims, which follow. It is contemplated by the inventors that various substitutions, alterations, and modifications may be made to the invention without departing from the spirit and scope of the invention as defined by the claims.

1. A method of recovering the contents from a microcapillary array having a plurality of wells each with mutually opposed first and second openings, the method comprising:
a) identifying a target well of the array for recovery from among a plurality of wells of the array;
b) bringing first and second recovery ducts into contact with the array in alignment respectively with the first and second openings of the identified target well to effect fluid communication between those ducts and that well through the respective first and second openings; and
c) by flowing fluid from the first recovery duct through the identified target well and into the second recovery duct, conveying contents of that well into the second recovery duct.

2. The method of claim 1, comprising creating an aperture in a film or films of the array that seals the first and/or second openings of the wells of the array, that aperture being created at a location corresponding to the identified target well before bringing the first and/or second recovery ducts into contact with the array in fluid communication with that well through the aperture.

3. The method of claim 2, wherein a film or films of the array seals the first and second openings of the wells of the array, and apertures are created at locations corresponding to the first and second openings of the identified target well.

4. The method of Claim wherein the aperture or apertures are created by a laser or lasers.

5. The method of claim 1, further comprising identifying a further target well for recovery and repeating steps b) and c) to recover the contents of the further target well.

6. (canceled)

7. The method of claim 1, further comprising a step of calibrating the positions of at least one of the first and second recovery ducts, the microcapillary array or a laser or lasers.

8. The method of claim 6, comprising using a calibration camera to determine the positions of the first and second recovery ducts, the laser or lasers, and/or the microcapillary array and/or using the determined positions to identify one or more of a laser-camera offset, a duct-camera offset, and/or a laser-duct offset.

9. (canceled)

10. The method of claim 1, wherein the contents of the target well comprise liquid media and/or one or more biological cells.

11. (canceled)

12. The method of claim 1, further comprising, before aligning the recovery ducts to the openings of the target well, a step of contacting the microcapillary array with a population of heterogeneous cells, such that a sub-population comprising at least one of said cells enters at least one well of the microcapillary array.

13. The method of claim 9, further comprising detecting a target sub-population of the heterogeneous cells and thereby identifying one or more target wells containing said sub-population, wherein the target sub-population is identified by determining interaction between at least one binding partner and a molecule produced by the target sub-population

14. The method of claim 9, further comprising reversibly attaching the microcapillary array to a substrate after the microcapillary array is contacted with the population of heterogeneous cells, such that part of the surface of the substrate is exposed to the contents of the wells of the microcapillary array, and wherein the substrate is removed before the step of aligning and contacting the first and second recovery ducts to the target well, suitably wherein at least one binding partner is attached to the substrate.

15. The method of claim 11, wherein the substrate or substrates are examined for interaction between at least one binding partner attached to the substrate and a molecule produced by the target sub-population in order to identify a target sub-population.

16. The method of claim 10, wherein at least one binding partner is present in the wells of the microcapillary array together with the population of heterogeneous cells.

17. A system for recovery of the contents of a microcapillary array, the system comprising components being:
an array stage for holding a microcapillary array;
a first recovery duct; and
a second recovery duct;
wherein at least one of said components is movable relative to at least one other of said components to contact the first and second recovery ducts with a microcapillary array held in the array stage, those ducts being in mutual alignment with a well in that microcapillary array.

18. The system of claim 14, wherein the first and/or second recovery ducts are fluidly coupled to a source of a liquid, such that a liquid can be flowed between the first and second recovery ducts, and through a well in a microcapillary array positioned between the first and second recovery ducts.

19. The system of claim 14, further comprising a component which is a penetrator for creating an aperture in a sealing film at a location corresponding to an opening of a target well.

20. The system of claim 16, wherein the penetrator comprises a first laser and a second laser, wherein the first and second lasers are configured to create apertures in a sealing film on opposing sides of a microcapillary array held in the array stage.

21. The system of claim 16, wherein the system comprises one or more cameras to determine the position and/or target location of the penetrator.

22. The system of claim 14, wherein the first and/or second duct comprises a force feedback device to determine the pressure between the duct and a contacted surface and/or a deformable tip or coating.

23. (canceled)

24. The system of claim 14, further comprising a calibration camera for determining the relative positions of the first and second recovery ducts, the laser or lasers, and/or the microcapillary array and/or wherein at least one of the components is coupled to one or more positioning stages to move them relative to the other components.

25. (canceled)
